(19) United States
(12) Patent Application Publication
(10) Pub. No.: US 2011/0047332 A1
(43) Pub. Date: Feb. 24, 2011

(54) STORAGE SYSTEM, CACHE CONTROL DEVICE, AND CACHE CONTROL METHOD

(75) Inventor: Tooru KOBAYASHI, Kawasaki (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/861,813

(22) Filed: Aug. 23, 2010

(30) Foreign Application Priority Data
Aug. 24, 2009 (JP) 2009-192800

(51) Int. Cl. G06F 12/08; G06F 12/00

(52) U.S. Cl. 711/122; 711/118; 711/E12.024; 711/E12.017

(57) ABSTRACT

A storage system includes a storage device that stores data, a cache memory that caches the data, an information storage unit that stores data configuration information indicating a configuration of the data and state information indicating a cache state of the data in the cache memory, a candidate data selection unit, a first determining unit and a data-to-be-written unit. The candidate data selection unit selects, according to the state information candidate data from the data cached in the cache memory. The first determination unit determines, according to the data configuration information, whether data relating to the candidate data is cached in the cache memory. The data-to-be-written selection unit selects, according to the determination made by the first determination unit, data to be written into the storage device, from the data cached in the cache memory.

### CROSS-REFERENCE TO RELATED APPLICATION

This application is related to and claims the benefit of priority to Japanese Patent Application No. 2009-192800, filed on Aug. 24, 2009, the entire contents of which are incorporated herein by reference.

### FIELD

Embodiments discussed herein relate to a cache control technology applicable to storages.

### BACKGROUND

Object-based storage systems are known as storage systems standardized by the American National Standards Institute (ANSI) T10. Block-based storage systems are known as storage systems that manage data in units different from those of object-based storage systems. Hereafter, a block-based storage system and an object-based storage system will be outlined. FIG. 7 schematically illustrates a block-based storage system and an object-based storage system.

As illustrated in FIG. 7, an object-based storage system 8 handles user data on an object basis and each object includes multiple blocks. The object-based storage system 8 transmits or receives data to or from a higher-level device on an object basis. On the other hand, a block-based storage system 7 handles user data on a block basis. The block-based storage system 7 has the prefetch function. The prefetch function refers to a function that improves access performance by detecting the continuity of blocks accessed by the higher-level device and previously fetching, into a cache, blocks continuing from blocks read from a storage device. Hereafter, the prefetch function will be described. FIG. 8 illustrates an example block prefetch using the prefetch function.

As illustrated in FIG. 8, it is assumed that the LBAs (logical block addresses) of data to be accessed by a higher-level device 91 are 00001000 to 00001029. In this case, a storage control device 92 controlling a storage device 93 in the block-based storage system 7 receives a request for reading 10 blocks starting with the LBA 00001000 from the higher-level device 91. The storage control device 92 then transfers the read-requested blocks from the storage device 93 to a cache memory 921. At that time, the storage control device 92 detects the continuity of the blocks to be accessed and caches the subsequent 10 blocks starting with the LBA 0001010 into the cache memory 921. Subsequently, when receiving a request for reading of 10 blocks starting with the LBA 00001010 from the higher-level device 91, the storage control device 92 transfers the data present in the cache memory 921 to the higher-level device 91.

In a case where data to be accessed is composed of continuing blocks or in a case where an entire volume is to be read, such a prefetch function allows the higher-level device 91 to access data present in the cache memory 921. This increases the speed at which the storage system returns data in response to read requests from the higher-level device.

Also, in the block-based storage system 7, upon receiving a request for writing of data from the higher-level device 91, the storage control device 92 caches the data in the storage control device 92. In this case, the cache memory 921 has a smaller capacity than that of the storage device 93. Accordingly, the storage control device 92 uses an algorithm for removing cached data, such as an LRU (least recently used) or MRU (most recently used). Hereafter, a cached-data removal algorithm will be outlined using an LRU as an example. FIG. 9 schematically illustrates an LRU.

As illustrated in FIG. 9, it is assumed that the LBAs 00001000 to 00001049 are to be newly entered into the cache memory as data to be written. The storage control device 92 monitors whether the cache memory is full. If the cache memory 921 is full, a cache block 2, which has been read least recently, is removed from the cache memory 921.

As illustrated in FIG. 9, the storage control device 92 removes the longest unused data from the cache memory 921 according to the cached-data removal algorithm so as to secure free space in the cache memory 921.

However, the data removed from the cache memory 921 according to the above-mentioned algorithm may be updated by the higher-level device 91. In this case, the storage control device 92 must again read the removed data from the storage device 93 into the cache memory 921. This problem occurs because the storage control device 92 cannot grasp the configuration of data handled by the higher-level device 91.

Further, the object-based storage system 8 manages data handled by the higher-level device 91 on an object basis; it performs cache control on a block basis. Accordingly, the object-based storage system 8 also has the same problem as that with the block-based storage system 7. Stated differently, conventionally, data cached within a cached memory is not managed based on an object ID or configuration information even in a conventional object-based storage system.

That is, the above-mentioned storage system again reads the data, which has been removed from the cache memory 921 into the storage device, from the storage device 93 into the cache memory 921.

### SUMMARY

A storage system includes, a storage device that stores data, a cache memory that caches the data, an information storage unit that stores data configuration information indicating a configuration of the data and state information indicating a cache state of the data in the cache memory, a candidate data selection unit that, according to the state information, selects candidate data from the data cached in the cache memory, the candidate data being a candidate for data to be written into the storage device, a first determination unit that, according to the data configuration information, makes a determination as to whether data relating to the candidate data is cached in the cache memory, and a data-to-be-written selection unit that, according to the determination made by the first determination unit, selects data to be written into the storage device, from the data cached in the cache memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed. These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF DRAWINGS

FIG. 1 illustrates the hardware configuration of a storage system according to an embodiment;

FIG. 2 illustrates control information;

FIG. 3 illustrates an operation that a Control Module (CM) performs in response to a write request;

FIG. 4 illustrates cache data;

FIG. 5 illustrates a cache process;

FIG. 6 illustrates an operation that a CM performs in response to a read request;

FIG. 7 schematically illustrates a block-based storage system and an object-based storage system;

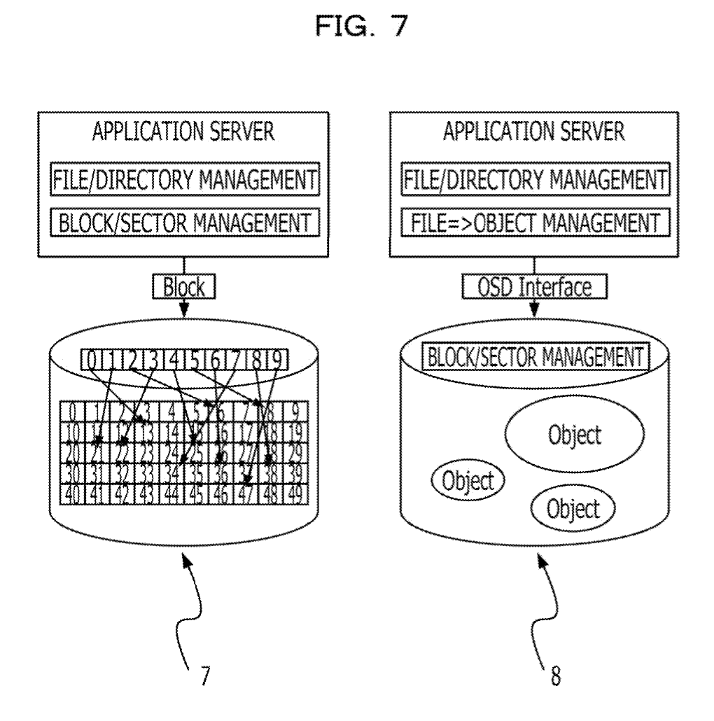

FIG. 8 illustrates an example block prefetch using the prefetch function; and

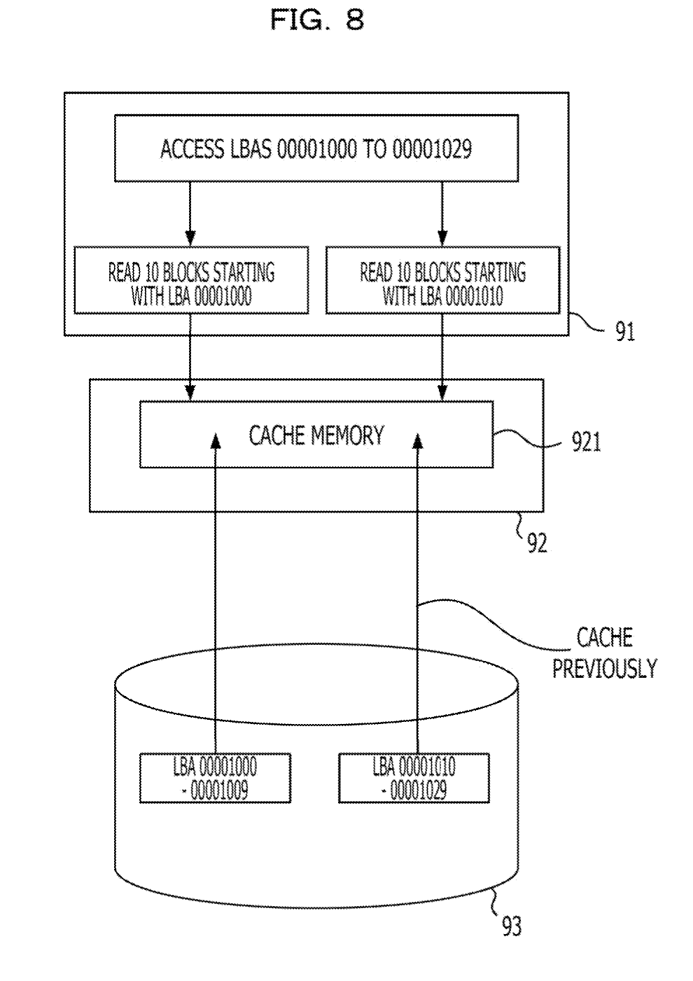

FIG. 9 schematically illustrates an LRU.

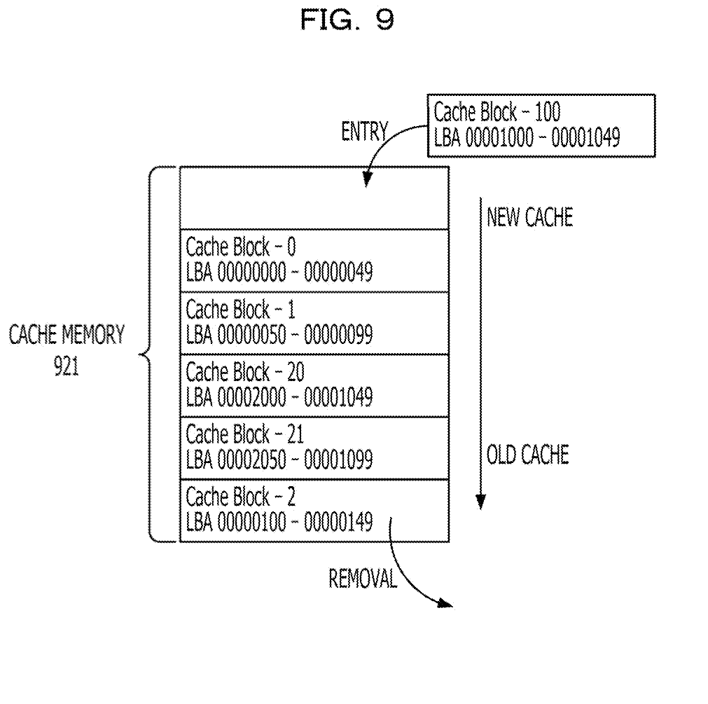

### DESCRIPTION OF EMBODIMENT(S)

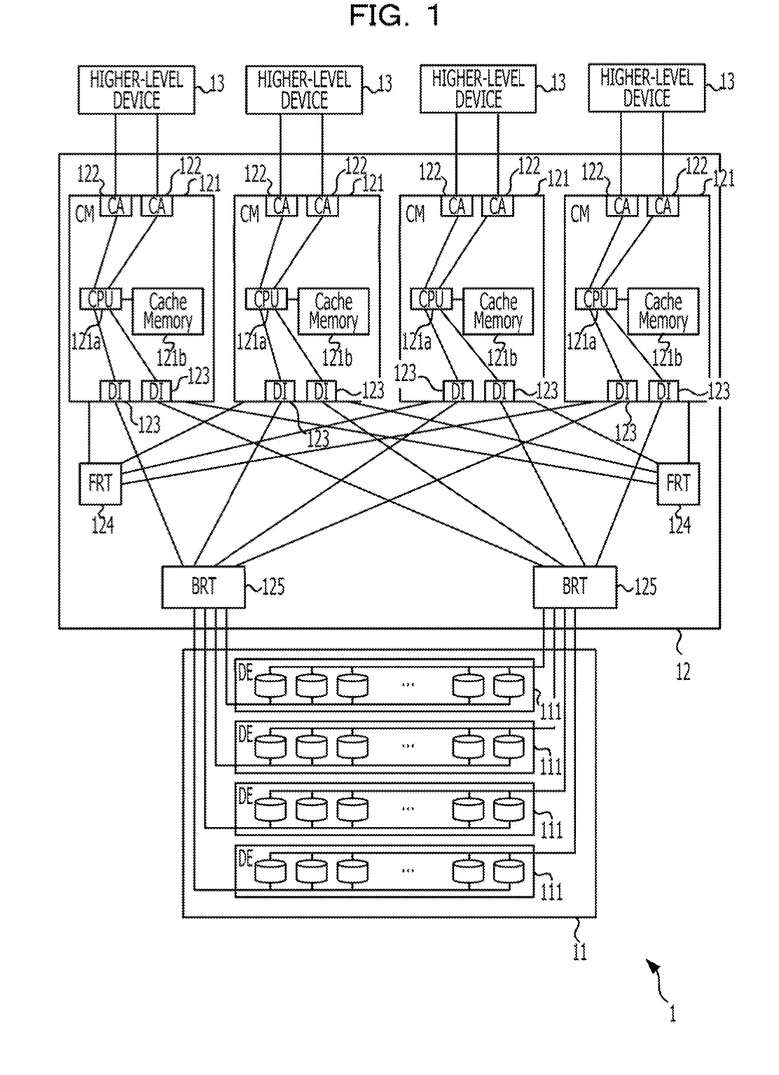

First, the hardware configuration of a storage system according to an embodiment will be described. FIG. 1 illustrates the hardware configuration of the storage system according to this embodiment.

As illustrated in FIG. 1, a storage system 1 according to this embodiment is an object-based storage system that handles user data on an object basis, and includes a storage device 11 and a storage control device 12. The storage device 11 includes multiple disk enclosures (DEs) 111. The DEs 111 each include multiple disk drives. The storage control device 12 controls the storage device 11 in accordance with requests from higher-level devices 13 such as server or host. The storage control device 12 includes multiple control modules (CMs) 121, multiple front-end routers (FRTs) 124, and multiple back-end routers (BRTs) 125. The storage system 1 is not limited to an object-based storage system and may be any type of storage system as long as the storage system grasps the configuration of data handled by any higher-level device 13.

Each CM (e.g., cache control device) 121 includes a central processing unit (CPU) 121a, a cache memory 121b, multiple channel adapters (CAs) 122, and multiple device interfaces (DIs) 123 and performs cache control, RAID control, and resource management on the storage device 11. Each CA 122 is an interface at which the corresponding CM 121 transmits or receives data to or from the corresponding higher-level device 13. In this embodiment, multiple CAs 122 are used for connection with a single higher-level device 13. Each DI 123 is an interface at which the corresponding CM 121 transmits or receives data to or from the storage device 11. Each CPU 121a controls the corresponding cache memory 121b, CAs 122, and DIs 123.

The FRTs 124 relay the connections between the multiple CMs 121. The BRTs 125 relay the connections between the multiple CMs 121 and multiple DEs 111. It is assumed that the FRTs 124 and BRTs 125 are redundant and that the execution systems and standby systems thereof are connected to the relay targets via different paths.

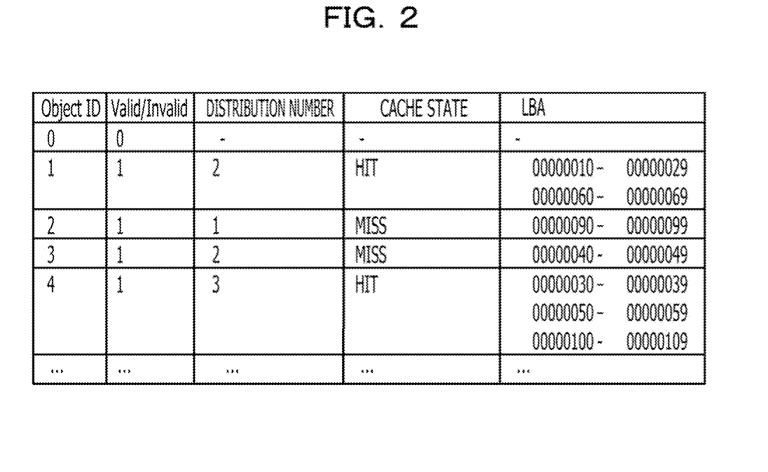

Next, control information will be described. FIG. 2 illustrates control information.

As illustrated in FIG. 2, in control information, object IDs (identifiers), valid/invalid, distribution numbers (data configuration information), cache states (state information), logical block addresses (LBAs; data configuration information) are associated with one another. Each object ID is an identifier unique to the corresponding object.

Among other things, a storage system in which object IDs are implemented as further described below provides an increased recognition of a relationship among data in the cache memory by managing the data in the cache memory with the object IDs. Accordingly, the storage system may have an improved cache hit rate when data reading request is received from a higher-level device.

The valid/invalid indicates whether an object identified by each object ID is valid, that is, whether there exists an object corresponding to each object ID. In the valid/invalid, “0” indicates invalid and “1” indicates valid. The distribution number represents the number of sections where blocks of an object are continuously arranged. The cache state indicates whether each object is cached in the cache memory 121b. In the cache state, “HIT” indicates that the object is cached and “MISS” indicates that the object is not cached. In this embodiment, if all blocks of an object are cached, the object is considered to be cached. The LBA indicates the addresses of blocks of each object. The control information is stored in the cache memories 121b or storage device 11, for example. The cache memories 121b or storage device 11 correspond to an information storage unit that stores data configuration information and state information.

According to an example embodiment, the above described object ID, cache state, distribution number and LBAs are used within a cache control method and a cache control device as described below. Although a conventional device such as those described in the background section of this application may include one or more of these pieces of information, these pieces of information conventionally are not used within a cache control method and a cache control device as described below. For example, a conventional object based system may include the use of LBA or object ID for managing data within a higher level device, however the LBA and/or object ID is unavailable or ignored by caching components of the conventional storage system or conventional caching control operations. Further, it is noted that an Object ID is not the same as a simple logical block address.

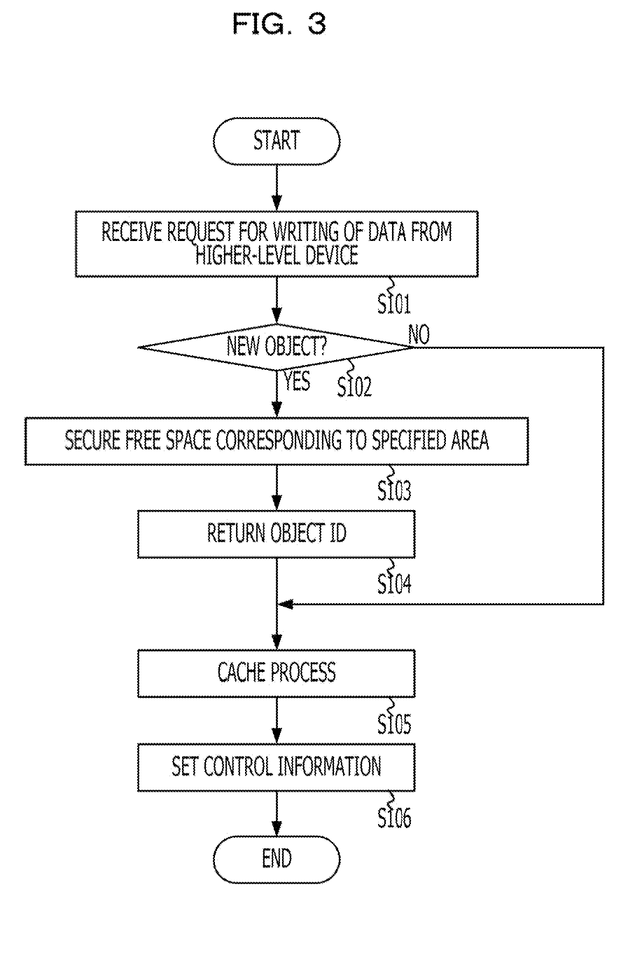

Next, an operation that a CM performs in response to a write request will be described. FIG. 3 illustrates an operation that a CM performs in response to a write request.

As illustrated in FIG. 3, a CPU 121a, for example, receives a request for writing of data from the corresponding higher-level device 13 (S101) and then determines whether the data is a new object (S102).

If the data is a new object (YES in S102), the CPU 121a secures free space corresponding to the area specified by the write request in the storage area of the storage device 11 (S103). The storage device 11 stores block information indicating the storage state of each block. The CPU 121a refers to the block information to secure free space. The block information may be stored in the CMs.

Next, the CPU 121a assigns an object ID to the data to be written and returns it to the write-requesting higher-level device 13 (S104). At that time, the CPU 121a refers to the valid/invalid in the control information to detect a free object ID and then assigns the object ID to the data to be written.

After returning the object ID, the CPU 121a performs a cache process (to be discussed in greater detail later) (S105). The CPU 121a then sets control information for the assigned object ID in accordance with the write request (S106). For example, at that time, the CPU 121a sets “1” for the valid/invalid and “HIT” for the cache state. The CPU 121a also stores, as control information, the number of blocks corresponding to the free space secured in response to the write request and the distribution number of the blocks. If there is an object, of which all blocks have been removed from the cache memory 121b in the cache process, the CPU 121a sets “MISS” for the cache state of the object.

If it is determined in S102 that the data is not a new object (NO in S102), the CPU 121a performs a cache process (S105), that is, updates an existing object. At that time, the higher-level device 13 specifies the object ID of the existing object. The function for performing S104 of FIG. 3 corresponds to a return unit.

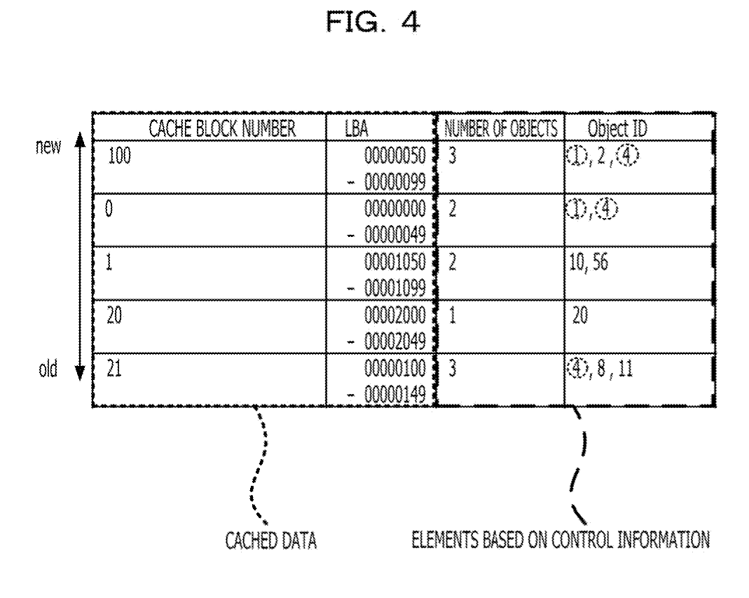

Next, cache data will be described. FIG. 4 illustrates cache data.

The cache data includes multiple cache blocks listed in the order of shortness of caching in the cache memory 121b. In this embodiment, each cache block includes 50 blocks, but the number of blocks included in each cache block is not limited thereto. In FIG. 4, each cache block number represents a number assigned to the corresponding cache block, and LBAs represent blocks included in the corresponding cache block. Note that “elements based on control information” in FIG. 4 is illustrative information including control information and may not actually be stored in the cache memory 121b.

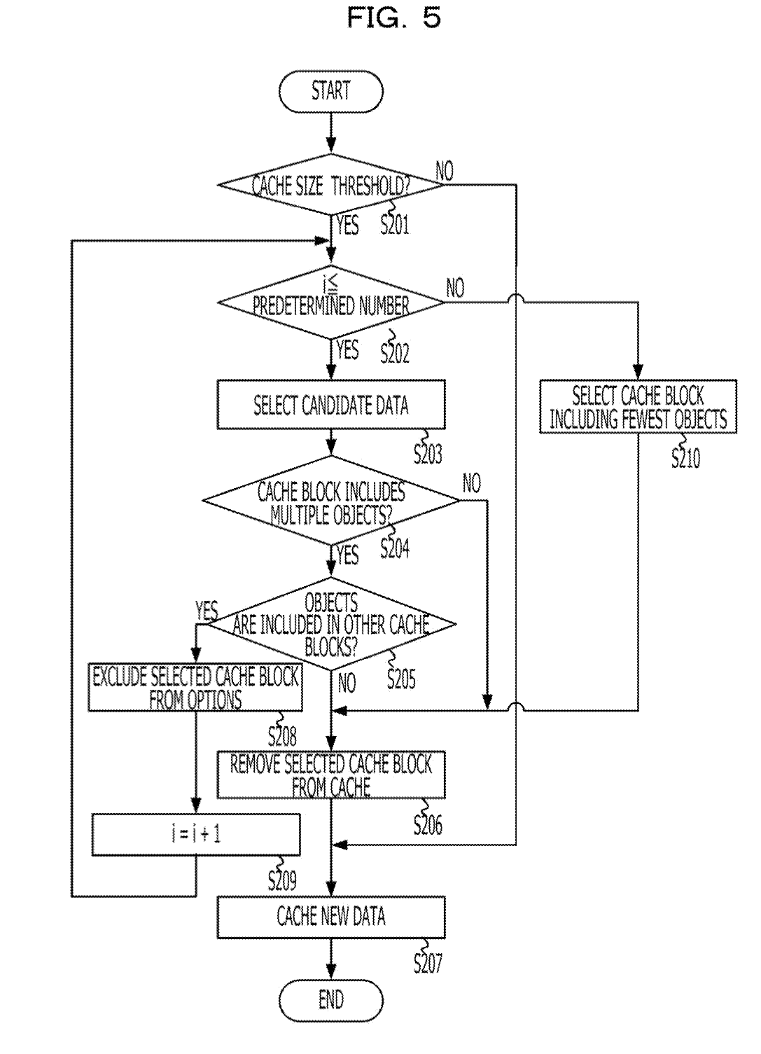

Next, the cache process will be described. FIG. 5 illustrates the cache process. In FIG. 5, it is assumed that i represents a counter of the number of times a cache block has been selected and that i is defaulted to 0.

As illustrated in FIG. 5, the CPU 121a determines whether the cache size of the cache memory 121b is equal to or greater than a specified and/or predetermined threshold (S201). The cache size compared to the threshold refers to the sum of cache blocks cached in the cache memory 121b and cache blocks to be newly cached in the cache memory 121b.

If the cache size is equal to or greater than the threshold (YES in S201), the CPU 121a determines whether i is equal to or smaller than a specified and/or predetermined number (S202).

If i is equal to or smaller than the number (YES in S202), the CPU 121a selects the cache block cached in the lowest row of the cache information as candidate data to be written into the storage device 11 (candidate data) (S203). The CPU 121a then refers to the control information to determine whether the cache block selected as a candidate includes multiple objects (S204).

If the cache block includes multiple objects (YES in S204), the CPU 121a determines, according to the control information, whether the objects included in the cache block are included in other cache blocks (S205). Specifically, the CPU 121a determines whether the same object IDs as those of the objects included in the cache block are included in other cache blocks. For example, in the cache data illustrated in FIG. 4, objects having object IDs of 1 and 4 are included in other cache blocks.

If the objects are not included in other cache blocks (NO in S205), the CPU 121a selects the cache block as a block to be written into the storage device 11 (data to be written). The CPU 121a then removes the cache block from the cache memory 121b (S206) and writes it into the storage device 11. The CPU 121a then caches new data (S207).

In contrast, if the objects are included in other cache blocks (YES in S205), the CPU 121a excludes the selected cache block from options (S208) and increments i by 1 (S209). Then, the CPU 121a again determines whether i is equal to or smaller than the number (S202).

If the cache block does not include multiple objects in S204 (NO in S204), the CPU 121a removes the selected cache block from the cache memory 121b (S206).

If i is not equal to or smaller than the number in S202 (NO in S202), the CPU 121a selects a cache block including the fewest objects (S210). The CPU 121a then removes the selected cache block from the cache memory 121b (S206).

If the cache size is smaller than the threshold in S201 (NO in S201), the CPU 121a caches new data (S207).

As described above, removing cached data in data units requested by the higher-level device 13, such as objects, can increase processing efficiency in cache control. A candidate data selection unit may perform S203 of FIG. 5. A first determination unit may perform S204 and S205. A data-to-be-written unit may perform S206. The candidate data selection unit, first determination unit and data-to-be-written unit may be a CPU operating in response to execution of programmable instructions stored in a memory, specialized hardware circuits and/or a programmable device configured to perform the respective operations.

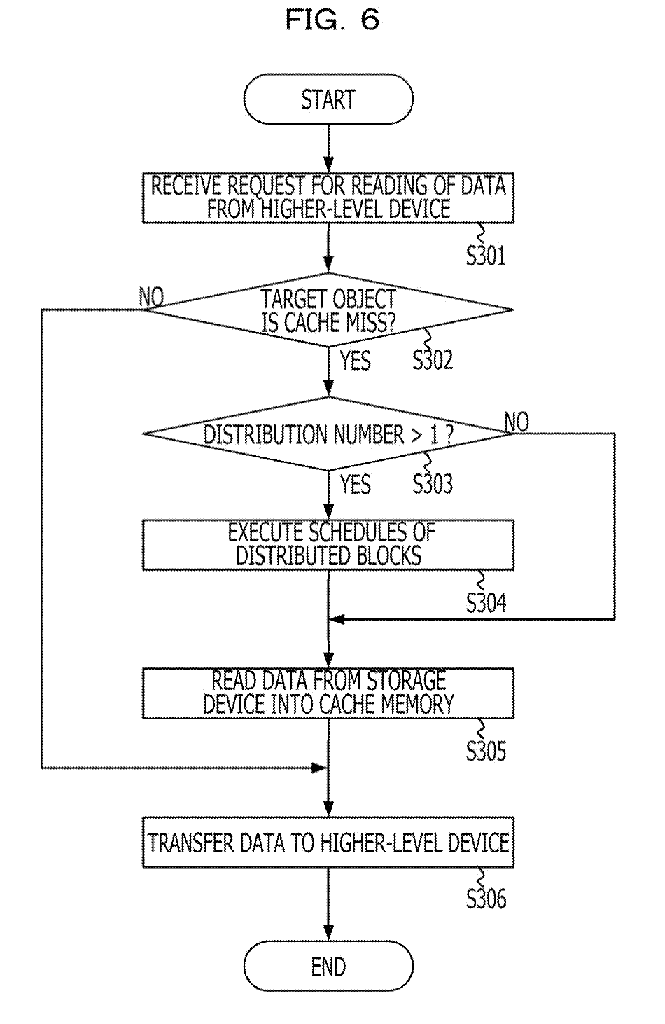

Next, an operation that a CM performs in response to a read request will be described. FIG. 6 illustrates an operation that a CM performs in response to a read request.

As illustrated in FIG. 6, when receiving a request for reading of data from the higher-level device 13 (S301), the CPU 121a refers to the control information to determine whether the object to be read (hereafter referred to as the “target object”) is a cache miss (S302).

If the target object is a cache miss (YES in S302), the CPU 121a refers to the control information to determine whether the distribution number of the target object is greater than 1, that is, whether the target object is distributed to multiple blocks (S303).

If the distribution number is greater than 1 (YES in S303), the CPU 121a executes the schedules of the distributed blocks (S304). Specifically, the CPU 121a selects the distributed blocks as data to be read from the storage device 11 into the cache memory 121b. Also, the CPU 121a retrieves a free cache block for data that is among the distributed blocks and that is not cached in the cache memory 121b, and assigns the retrieved free cache block to the data.

The CPU 121a then caches data of the target object from the storage device 11 into the cache memory 121b (S305). At that time, the CPU 121a prefetches the read-requested data in accordance with the configuration of the data and caches the prefetched data in the cache memory 121b. The CPU 121a also updates the control information with respect to the cached object. The CPU 121a then transfers the cached data to the higher-level device 13 (S306).

If the distribution number of the target object is 1 (NO in S303), the CPU 121a caches data of the target object from the storage device 11 into the cache memory 121b (S305). The CPU 121a then transfers the cached target object data to the higher-level device 13 (S306).

If the target object is not a cache miss in step S302 (NO in S302), the CPU 121a transfers the cached target object data to the higher-level device 13 (S306).

A second determination unit may perform S303 of FIG. 6. A data-to-be-read selection unit may perform S304. The second determination unit and the data-to-be-read selection unit may be a CPU operating in response to execution of programmable instructions stored in a memory, specialized hardware circuits and/or a programmable device configured to perform the respective operations.

As seen, if an uncached object is stored in the storage device 11 in a distributed manner, the storage system 1 performs cache control in accordance with the configuration of the data handled by the higher-level device 13. This allows only necessary data to be loaded or pre-fetched into or from the cache memory, thereby increasing the use efficiency of the cache memory and the data transfer efficiency.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

1. A storage system that stores data, comprising:
a storage device that stores the data;
a cache memory that caches the data;
an information storage unit that stores data configuration information indicating a configuration of the data and state information indicating a cache state of the data in the cache memory;
a candidate data selection unit that, according to the state information, selects candidate data from the data cached in the cache memory, the candidate data being a candidate for data to be written into the storage device;
a first determination unit that, according to the data configuration information, makes a determination as to whether data relating to the candidate data is cached in the cache memory; and
a data-to-be-written selection unit that, according to the determination made by the first determination unit, selects data to be written into the storage device, from the data cached in the cache memory.

2. The storage system according to claim 1, further comprising
a return unit that, when receiving data in a pre-notified amount from a higher-level device, sets an identifier for the received data and returns the identifier to the higher-level device.

3. The storage system according to claim 2, wherein
the data configuration information indicates a data configuration for each identifier.

4. The storage system according to claim 3, wherein
the first determination unit determines whether data having the same identifier as an identifier of the candidate data is cached in the cache memory.

5. The storage system according to claim 3, wherein
the data configuration information indicates whether the data stored in the storage device is stored in a distributed manner, and the storage system further comprises:
a second determination unit that, according to the data configuration information, determines whether data requested by the higher-level device is stored in the storage device in a distributed manner; and
a data-to-be-read selection unit that, if the second determination unit determines that the requested data is stored in the storage device in a distributed manner, selects the requested data as data to be read from the storage device into the cache memory.

6. The storage system according to claim 4, wherein
if the first determination unit determines that data having the same identifier as an identifier of the candidate data is not cached in the cache memory, the data-to-be-written selection unit selects the candidate data as data to be written into the storage device.

7. A cache control device comprising:
a cache memory that caches data to be stored in a storage device;
an information storage unit that stores data configuration information indicating a configuration of the data and state information indicating a cache state of the data in the cache memory;
a candidate data selection unit that, according to the state information, selects candidate data from the data cached in the cache memory, the candidate data being a candidate for data to be written into the storage device;
a first determination unit that, according to the data configuration information, makes a determination as to whether data relating to the candidate data is cached in the cache memory; and
a data-to-be-written selection unit that, according to the determination made by the first determination unit, selects data to be written into the storage device, from the data cached in the cache memory.

8. The cache control device according to claim 7, further comprising
a return unit that, when receiving data in a pre-notified amount from a higher-level device, sets an identifier for the received data and returns the identifier to the higher-level device.

9. The cache control device according to claim 8, wherein
the data configuration information indicates a data configuration for each identifier.

10. The cache control device according to claim 9, wherein
the first determination unit determines whether data having the same identifier as an identifier of the candidate data is cached in the cache memory.

11. The cache control device according to claim 9, wherein
the data configuration information indicates whether the data stored in the storage device is stored in a distributed manner, and the cache control device further comprises:
a second determination unit that, according to the data configuration information, determines whether data requested by the higher-level device is stored in the storage device in a distributed manner; and
a data selection unit that, if the second determination unit determines that the requested data is stored in the storage device in a distributed manner, selects the requested data as data to be read from the storage device into the cache memory.

12. The cache control device according to claim 10, wherein
if the first determination unit determines that data having the same identifier as an identifier of the candidate data is not cached in the cache memory, the data-to-be-written selection unit selects the candidate data as data to be written into the storage device.

13. A method for controlling cache using a control device that caches data in a cache memory, the data being data to be stored into a storage device, the method comprising:
(a) selecting candidate data from the data cached in the cache memory in accordance with state information indicating a cache state of the data in the cache memory, the candidate data being a candidate for data to be written into the storage device;
(b) determining whether data relating to the candidate data is cached in the cache memory, in accordance with data configuration information indicating a configuration of the data; and
(c) selecting data to be written into the storage device from the data cached in the cache memory on the basis of the determination.

14. The method for controlling cache according to claim 13, further comprising
(d) when receiving data in a pre-notified amount from a higher-level device, setting an identifier for the received data and returning the identifier to the higher-level device.

15. The method for controlling cache according to claim 14, wherein
the data configuration information indicates a data configuration for each identifier.

16. The method for controlling cache according to claim 15, wherein
the determining determines whether data relating to the candidate data is cached in the cache memory based on determination of whether data having the same identifier as an identifier of the candidate data is cached in the cache memory.

17. The method for controlling cache according to claim 15, wherein
the data configuration information indicates whether the data stored in the storage device is stored in a distributed manner, and the method further comprises
(e) when, according to the data configuration information, determining that data requested by the higher-level device is stored in the storage device in a distributed manner, selecting the requested data as data to be read from the storage device into the cache memory.

18. The method for controlling cache according to claim 16, wherein
the data to be written is selected when the determining determines that data having the same identifier as an identifier of the candidate data is not cached in the cache memory.
